(19) United States
(12) Patent Application Publication
(10) Pub. No.: US 2026/0219093 A1
(43) Pub. Date: Jul. 30, 2026

(54) WORKPIECE MASS ESTIMATION DEVICE

(71) Applicant: FANUC CORPORATION, Yamanashi (JP)

(72) Inventor: Yuuya KAWASE, Minamitsuru-gun, Yamanashi (JP)

(73) Assignee: FANUC CORPORATION, Yamanashi (JP)

(21) Appl. No.: 19/147,314

(22) PCT Filed: Jan. 27, 2023
(86) PCT No.: PCT/JP2023/002649

§ 371 Date: Jul. 10, 2025

(51) Int. Cl. G01G 9/00

(52) U.S. Cl. CPC G01G 9/00

(57) ABSTRACT

The purpose of the present invention is to enable accurate estimation of the mass of a workpiece. This workpiece mass estimation device comprises a vibrating unit, a calculation unit, an identification unit, and an estimation unit. The oscillation unit commands a motor control unit to perform sweep oscillation that oscillates output of a motor and varies the oscillation frequency. The calculation unit, on the basis of motor information detected at a plurality of detection times within the period of execution of the sweep oscillation, calculates the overall inertia as the inertia of a driven body for each detection time. The identification unit identifies the time, within the execution period, that has the oscillation frequency for which the change in the overall inertia associated with the change to the adjacent oscillation frequency is determined to be the least. The estimation unit, by calculating a value obtained by subtracting the inertia of a general driven body that includes a rotor, a transmission mechanism, and a workpiece loading unit from the overall inertia corresponding to the identified time, calculates the inertia of a workpiece to estimate the mass of the workpiece.

### TECHNICAL FIELD

The present disclosure relates to a workpiece mass estimation device that estimates the mass of a workpiece loaded on various machines such as machine tools.

### BACKGROUND ART

Some machines such as machine tools each include a workpiece loading unit, a motor, a sensor, and a motor control unit. Workpieces are loaded on the workpiece loading unit. The motor drives the workpiece loading unit. The sensor detects the state of the motor. The state of the motor includes, for example, a current value and a rotational speed of the motor. The motor control unit performs feedback control of the motor based on the detected state of the motor.

### CITATION LIST

### Patent Document

Patent Document 1: Japanese Unexamined Patent Application, Publication No. 2015-55923

### DISCLOSURE OF THE INVENTION

### Problems to be Solved by the Invention

The total mass of the driven object driven by the motor varies depending on the mass of the workpiece loaded on the workpiece loading unit. Therefore, the inertia of the driven object also varies depending on the mass of the workpiece. The acceleration/deceleration of the driven object by the motor is changed by the change in the inertia. Excessive acceleration/deceleration imposes an excessive load on the machine, leading to machine failure, while insufficient acceleration/deceleration reduces the working efficiency of the machine. Therefore, it is necessary to adjust the acceleration/deceleration of the driven object by the motor to the optimal acceleration/deceleration. Therefore, some machines adjust the acceleration/deceleration of the driven object by the motor to the optimal acceleration/deceleration based on the mass of the workpiece input by the operator.

According to such a technique, although the acceleration/deceleration of the driven object can be adjusted, it is necessary for the operator to manually input the mass of the workpiece each time. Therefore, it has been proposed to automatically estimate the mass of the workpiece in the following manner. First, an oscillation command to oscillate the motor output is sent to the motor control unit of the machine to oscillate the motor output. The inertia of the driven object at this time is identified based on motor information such as a current feedback value and a rotational speed feedback value detected by the sensor. The inertia of the workpiece is calculated by subtracting the inertia caused by factors other than the workpiece from the identified inertia of the driven object, and the mass of the workpiece is estimated.

However, the present disclosers have focused on the fact that the following issue may occur in such a configuration. That is, when the oscillation frequency is a predetermined frequency such as a resonance frequency with the machine, a large error occurs in the motor information detected by the sensor, and a large error occurs in the calculated inertia. As a result, the mass of the workpiece cannot be estimated with high accuracy.

The present disclosure has been made in view of the above circumstances, and an object of the present disclosure is to enable estimation of the mass of a workpiece with high accuracy.

### Means for Solving the Problems

A workpiece mass estimation device of the present disclosure is a workpiece mass estimation device for estimating a mass of a workpiece,
for a machine including: a workpiece loading unit on which the workpiece is loaded; a motor including a rotor and a stator for rotating the rotor; a transmission mechanism for transmitting a motor output as a force for rotating the rotor to the workpiece loading unit; a sensor for detecting motor information indicating a state of the motor; and a motor control unit for controlling the motor based on the detected motor information, in which the machine drives a driven object including the rotor, the transmission mechanism, the workpiece loading unit, and the workpiece by the motor output. The workpiece mass estimation device includes:
an oscillation unit configured to command the motor control unit to perform sweep oscillation that oscillates the motor output and varies an oscillation frequency;
a calculation unit configured to, based on the motor information detected at a plurality of detection time points within an execution period of the sweep oscillation, calculate a total inertia as an inertia of the driven object for each detection time point;
an identification unit configured to identify a time point of an oscillation frequency at which it is determined that a change in the total inertia accompanying a change to an adjacent oscillation frequency is minimized within the execution period; and
an estimation unit configured to estimate the mass of the workpiece by calculating an inertia of the workpiece by subtracting an inertia of a general driven object including the rotor, the transmission mechanism, and the workpiece loading unit from the total inertia corresponding to the identified time point.

### BRIEF DESCRIPTION OF THE DRAWINGS

FIG. 1 is a configuration diagram showing a workpiece mass estimation device and a machine tool according to the present embodiment;

FIG. 2 is a graph showing the relationship between an oscillation frequency and estimated total inertia;

FIG. 3 is a graph showing waveforms of detected values in a frequency band other than a first frequency band;

FIG. 4 is a graph showing waveforms of detected values in the first frequency band;

FIG. 5 is a graph showing transitions of detected current values;

FIG. 6 is a graph showing changes in waveform due to sweep oscillation;

FIG. 7 is a graph showing the relationship between an oscillation frequency and estimated total inertia;

FIG. 8 is an enlarged view of a portion VIII shown in FIG. 7; and

FIG. 9 is a flowchart showing a procedure for estimating the mass of a workpiece.

### PREFERRED MODE FOR CARRYING OUT THE INVENTION

### First Embodiment

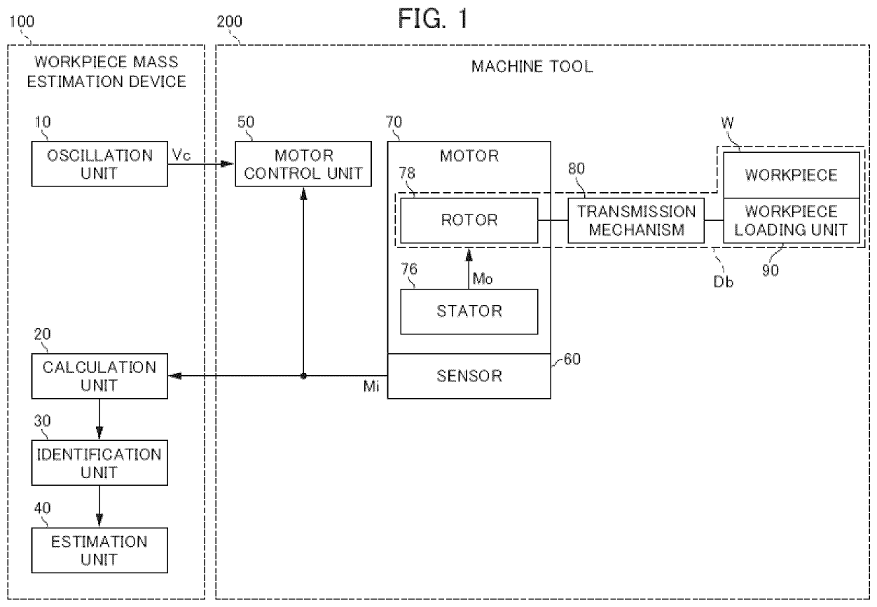

As shown in FIG. 1, a workpiece mass estimation device 100 of the present embodiment is installed for a machine tool 200. The machine tool 200 includes a motor control unit 50, a sensor 60, a motor 70, a transmission mechanism 80, and a workpiece loading unit 90.

The workpiece loading unit 90 is provided to be movable in a rotational direction or a linear direction. A workpiece W is loaded on the workpiece loading unit 90. The motor 70 includes a rotor 78 and a stator 76 that rotates the rotor 78. Hereinafter, the output from the stator 76 to the rotor 78 is referred to as “motor output Mo”. The transmission mechanism 80 transmits the motor output Mo from the rotor 78 to the workpiece loading unit 90. The transmission mechanism 80 may include a speed reducer such as a gear.

Hereinafter, the component group driven by the motor output Mo is referred to as a “driven object Db”. The driven object Db includes the rotor 78, the transmission mechanism 80, the workpiece loading unit 90, and the workpiece W. Hereinafter, the component group excluding the workpiece W from the driven object Db is referred to as a “general driven object”. Hereinafter, the inertia of the driven object Db is referred to as “total inertia J”, and the inertia of the general driven object is referred to as “general inertia”.

The sensor 60 detects motor information Mi indicating the state of the motor 70. The motor information Mi includes a current value of the motor 70 and a rotational speed of the rotor 78, The motor control unit 50 performs feedback control of the motor 70 based on the motor information Mi detected by the sensor 60.

Next, the workpiece mass estimation device 100 will be described. The workpiece mass estimation device 100 includes an oscillation unit 10, a calculation unit 20, an identification unit 30, and an estimation unit 40. The oscillation unit 10, the calculation unit 20, the identification unit 30, and the estimation unit 40 are configured mainly by the same computer, for example. The computer includes, for example, a CPU, a ROM, a RAM, and a memory. In FIG. 1, the workpiece mass estimation device 100 and the machine tool 200 are shown separately from each other, but the workpiece mass estimation device 100 may be incorporated into the machine tool 200.

The oscillation unit 10 outputs an oscillation command Vc to the motor control unit 50. The oscillation command Vc is a command to oscillate the motor output Mo. More specifically, the oscillation command Vc is a command to add a sinusoidal command of a constant frequency to, for example, a position command, a torque command, or a rotational speed command by the motor control unit 50.

The calculation unit 20 calculates the total inertia J based on a current value Iq of the motor 70 and a rotational speed ω of the rotor 78 detected by the sensor 60 within the execution period of the oscillation. Specifically, for example, the total inertia J is calculated based on the following Equation 1.

$$\begin{matrix}[ Equation 1 ] & \\ f = \frac{{K}_{t} \cdot \overline{{I}_{q}} - F ( ω )}{\frac{\overline{d ω}}{dt}} & ( Equation 1 )\end{matrix}$$

In Equation 1, “Kt” is a torque constant Kt of the motor 70, “Iq” is the current value Iq of the motor 70, “ω” is the rotational speed ω of the rotor 78, and “t” is an elapsed time t. In Equation 1, “ ” indicates the average value of values sampled within a certain number of seconds.

In Equation 1, “F(ω)” is a frictional force F(ω). The frictional force F(ω) is the sum of the viscous friction and the Coulomb friction, and is expressed as a function of the rotational speed ω of the rotor 7θ. In Equation 1, the frictional force F(ω), which is the latter term, may be ignored if the frictional force F(ω) is minute compared to the product of the torque constant Kt and the average current value, which is the former term. In a case where the frictional force F(ω) is not minute, for example, a frictional force F(ω) ascertained in advance is substituted into F(ω) of Equation 1.

The estimation unit 40 calculates the inertia of the workpiece W by subtracting the general inertia stored in advance from the total inertia J calculated by the calculation unit 20, and estimates the mass of the workpiece W.

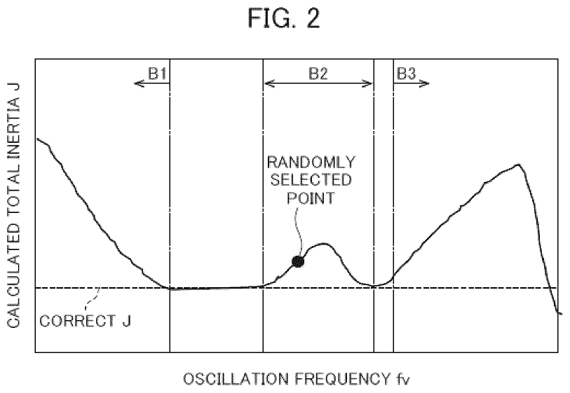

Next, problems to be solved by the present embodiment will be described with reference to FIGS. 2 to 5. Hereinafter, the frequency at which the motor output Mo is oscillated is referred to as an “oscillation frequency fv”. Depending on the oscillation frequency fv, a large error occurs in the motor information Mi detected during the execution of the oscillation, and a large error also occurs in the calculated total inertia J. As a result, the mass of the workpiece W cannot be estimated with high accuracy.

Specifically, the following first to third frequency bands B1 to B3 are the frequency bands in which large errors may occur.

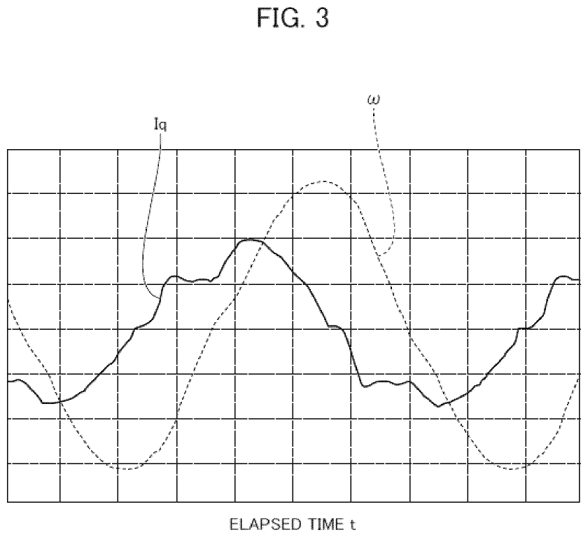

First, the first frequency band B1 shown on the left side of FIG. 2 will be described. The first frequency band B1 is a frequency band in which the moving speed of the workpiece loading unit 90 becomes so slow that the Coulomb friction becomes dominant. In a frequency band larger than the first frequency band B1, the Coulomb friction F(ω) becomes sufficiently small. Therefore, as shown in FIG. 3, there are no dead zones in the current value Iq and the rotational speed ω. The dead zone here refers to a section in which the value hardly changes.

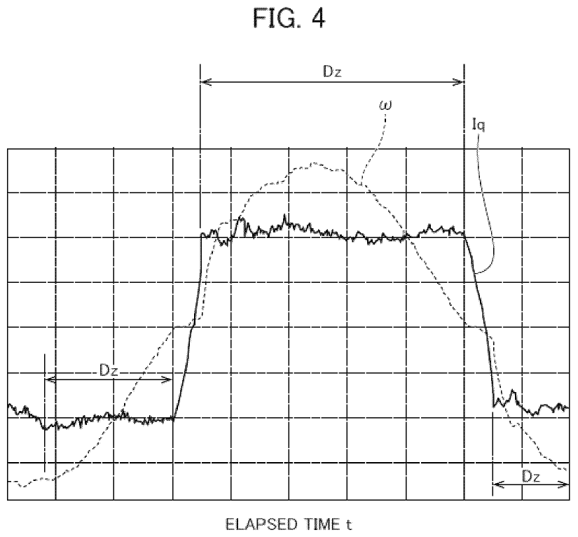

On the other hand, in the first frequency band B1, a behavior like stick-slip occurs in the movement of the workpiece loading unit 90 due to Coulomb friction. Therefore, as shown in FIG. 4, a dead zone Dz occurs in one or both of the current value Iq and the rotational speed ω. Due to the dead zone Dz, as shown in FIG. 2, the error of the calculated total inertia J increases in the first frequency band B1, and the mass of the workpiece W cannot be estimated with high accuracy.

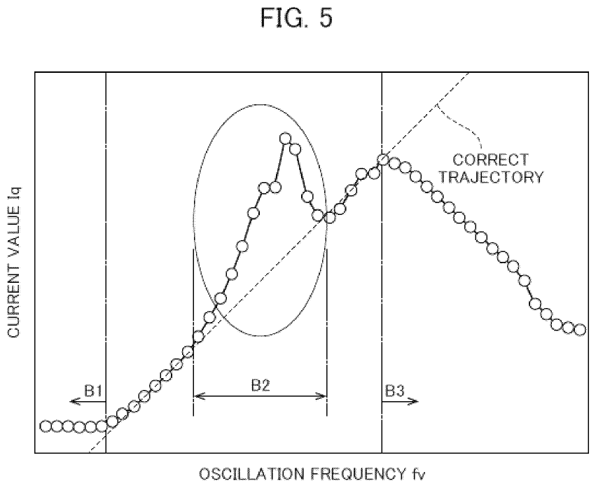

Next, the second frequency band B2 shown in a central portion between the left and right sides of FIG. 2 will be described. The second frequency band B2 is a frequency band in which the commanded oscillation frequency fv overlaps the natural frequency of the entire machine tool 200. In the second frequency band B2, the current value Iq is amplified as shown in FIG. 5. As a result, in the second frequency band B2, the error of the calculated total inertia J increases as shown in the central portion between the left and right sides of FIG. 2, and the mass of the workpiece W cannot be estimated with high accuracy.

Next, the third frequency band B3 shown on the right side of FIG. 2 will be described. The third frequency band B3 is a frequency at which the moving speed of the workpiece loading unit 90 becomes so fast that the moving speed is out of the band of control response in the control of the motor 70. In the third frequency band B3, the current value becomes unstable as shown in FIG. 5. Therefore, in the third frequency band B3, as shown on the right side of FIG. 2, the error of the total inertia J becomes large, and the mass of the workpiece W cannot be estimated with high accuracy.

Therefore, if the oscillation frequency fv is randomly selected as shown in FIG. 2, the oscillation frequency fv belonging to any of the first to third frequency bands B1, B2, and B3 may be selected. In this case, the mass of the workpiece W cannot be estimated with high accuracy.

In order to solve the above problems, in the present embodiment, the above-described oscillation unit 10 and calculation unit 20 shown in FIG. 1 are configured as follows, and the workpiece mass estimation device 100 further includes the identification unit 30.

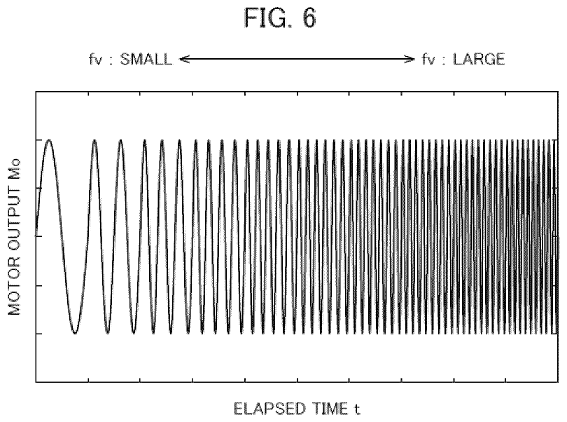

As shown in FIG. 6, the oscillation unit 10 commands the motor control unit 50 to perform sweep oscillation in which the oscillation frequency fv is varied within a predetermined variation range vR. Specifically, the oscillation unit 10 inputs the torque command value for oscillation to the motor control unit 50, and commands the sweep oscillation by varying the oscillation frequency fv of the torque command value.

At this time, the oscillation unit 10 varies the oscillation frequency fv from the end on the low frequency side toward the high frequency side of the variation range vR. However, instead of this, the oscillation frequency fv may be varied from the end on the high frequency side toward the low frequency side of the variation range vR. The oscillation unit 10 is capable of changing the variation range vR, in which the oscillation frequency fv is varied in the sweep oscillation, by an operator or the like.

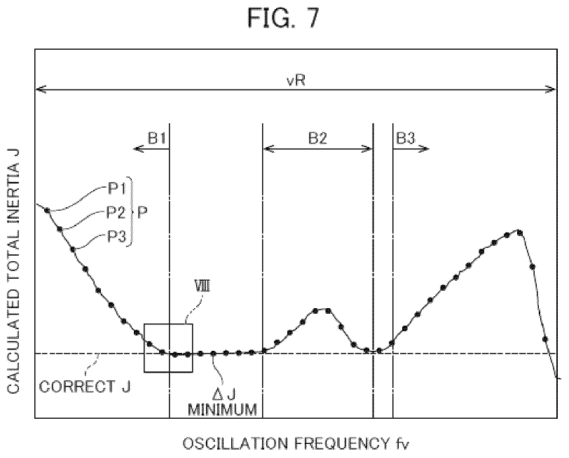

When the sweep oscillation is executed, the sensor 60 shown in FIG. 1 detects the motor information Mi at a plurality of detection time points P belonging to the execution period of the sweep oscillation. As shown in FIG. 7, the calculation unit 20 calculates the total inertia J for each detection time point P based on the motor information Mi at the plurality of detection time points P.

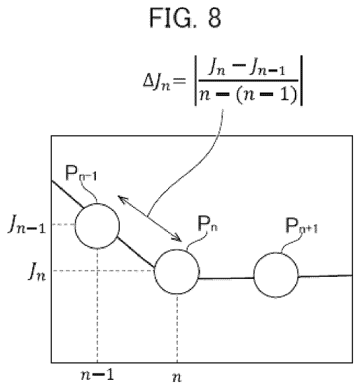

Hereinafter, a change in the total inertia J between adjacent detection time points Pₙ₋₁ and Pₙ is referred to as “rate of change ΔJ”. As shown in FIG. 8, the calculation unit 20 calculates the rate of change at each detection time point P. The calculation is performed based on, for example, the following Equation 2.

$$\begin{matrix}[ Equation 2 ] & \\ Δ {J}_{n} = \vert \frac{{J}_{n} - {J}_{n - 1}}{n - ( n - 1 )} \vert & ( Equation 2 )\end{matrix}$$

Here, “Jₙ” is the total inertia J at the nth detection time point Pₙ, and “Jₙ₋₁” is the total inertia J at the (n−1)th detection time point Pₙ₋₁. “ΔJₙ” is the rate of change ΔJ between the (n−1)th detection time point Pₙ₋₁ and the nth detection time point Pₙ.

The identification unit 30 identifies the detection time point P at which the rate of change ΔJ is minimum from the plurality of detection time points P at which the rate of change ΔJ is calculated by the calculation unit 20. Thereby, the oscillation frequency fv at which it is determined that the change in the total inertia J accompanying a change to an adjacent oscillation frequency fv is minimized from among the oscillation frequencies fv within the execution period of the sweep oscillation, that is, within the predetermined variation range vR shown in FIG. 7 is identified. Thus, the identification unit 30 easily identifies the oscillation frequency fv that does not overlap any of the first to third frequency bands B1, B2, and B3 shown in FIG. 7.

This is because, first, in the first frequency band B1, since the estimated total inertia J always falls downward to the right, the rate of change ΔJn is likely to increase. In the second and third frequency bands B3, since the estimated total inertia J turns downward to the right immediately after rising to the right, the rate of change ΔJn is likely to increase. Thus, at the detection time point P of the oscillation frequency fv not belonging to any of the first to third frequency bands, the rate of change ΔJ is likely to be minimum.

However, in the second and third frequency bands B2, the total inertia Jₙ₋₁ at the (n−1)th detection time point Pₙ₋₁ and the total inertia Jₙ at the nth detection time point Pn may become substantially equal to each other by chance on both sides sandwiching the top of the curve indicating the transition of the estimated total inertia J. In this case, the rate of change ΔJ at the detection time point P near the top in the second or third frequency band B2 may be minimum.

In order to surely avoid such a drawback, the identification unit 30 may be configured to identify the detection time point at which the rate of change ΔJ is minimum based on an additional condition. Specifically, for example, after the detection time point P at which the rate of change ΔJ is minimum is identified in the above Equation 2, the rate of change ΔJn is recalculated by replacing “n−1” with “n−2” in Equation 2. In this case, when the rate of change ΔJₙ exceeds a predetermined value, the detection time point P at which the rate of change ΔJ is minimum may be identified from among the remaining detection time points P excluding the detection time point P in question.

The estimation unit 40 shown in FIG. 1 calculates the inertia of the workpiece W by subtracting the general inertia from the total inertia J at the detection time point P identified by the identification unit 30, and estimates the mass of the workpiece W.

Thereafter, the estimation unit 40 transmits, for example, the estimated mass of the workpiece W to the motor control unit 50. In this case, the motor control unit 50 changes the mode of control of the motor 70 and the conditions for acceleration and deceleration based on the received mass of the workpiece W.

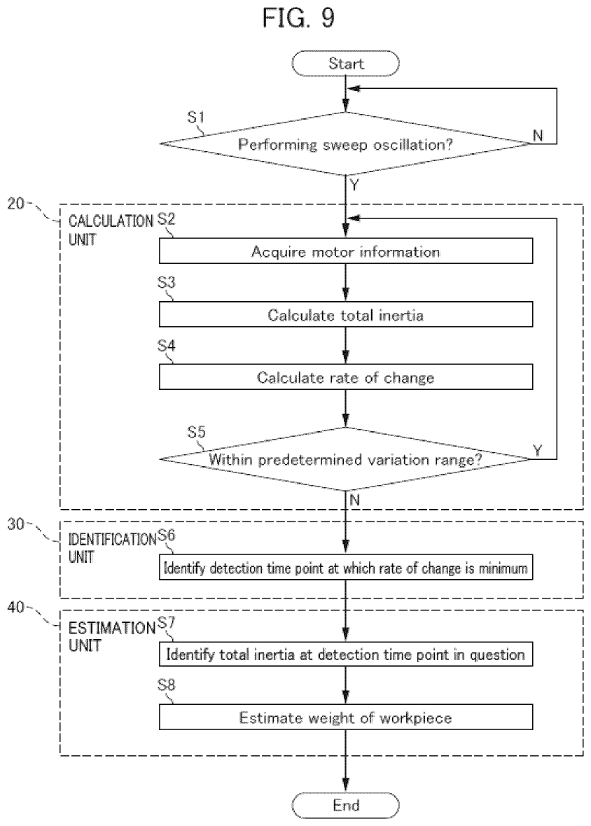

Next, with reference to FIG. 9, the flow of the mass estimation of the workpiece W described above will be described. In the following description, “S” is an abbreviation for “step”.

First, in S1, the workpiece mass estimation device 100 determines whether sweep oscillation is being performed. When a negative determination N (No) is made, for example, the determination of S1 is repeated every predetermined time. On the other hand, when an affirmative determination Y (Yes) is made, the processing advances to the next S2.

In S2, the calculation unit 20 acquires the motor information Mi from the sensor 60. In S3, the calculation unit 20 calculates the total inertia J based on the motor information Mi. In S4, the calculation unit 20 calculates the rate of change ΔJ based on the total inertia Jₙ at the current detection time point Pa and the total inertia Jₙ₋₁ at the previous detection time point Pₙ₋₁. In S5, the calculation unit 20 determines whether the current oscillation frequency fv is within the predetermined variation range vR. When an affirmative determination Y is made, the processing returns to S2. On the other hand, when a negative determination N is made in S5, the processing advances to S6.

In S6, the identification unit 30 identifies the detection time point P at which the rate of change ΔJ is minimum from among the plurality of detection time points P at which the rate of change ΔJ is calculated.

In S7, the estimation unit 40 identifies the total inertia J at the identified detection time point P. In S8, the estimation unit 40 calculates the inertia of the workpiece W by subtracting the general inertia from the identified total inertia J, and estimates the mass of the workpiece W.

The features and effects of the present embodiment will be summarized below.

The oscillation unit 10 inputs the torque command value for oscillation to the motor control unit 50, and enables the motor control unit 50 to perform sweep oscillation by varying the oscillation frequency fv of the torque command value.

The calculation unit 20 calculates the total inertia for each detection time point P based on the motor information Mi detected at the plurality of detection time points P within the execution period of the sweep oscillation. The identification unit 30 identifies the time point of the oscillation frequency fv at which it is determined that the change in the total inertia accompanying a change to an adjacent oscillation frequency fv is minimized within the execution period of the sweep oscillation. Accordingly, as described above, the time point of the oscillation frequency fv that does not overlap any of the first to third frequency bands B1, B2, and B3 can be efficiently identified.

The estimation unit 40 calculates the inertia of the workpiece W by subtracting the general inertia from the total inertia J corresponding to the time point identified in this manner, and estimates the mass of the workpiece W. Thus, the mass of the workpiece W can be estimated with high accuracy. Based on the highly accurately estimated mass of the workpiece W, the machine tool 200 can adjust the motor output Mo to an appropriate value without excess or deficiency, for example, and adjust the acceleration/deceleration of the driven object Db to an appropriate value without excess or deficiency.

Moreover, the oscillation unit 10 is capable of changing the variation range vR in which the oscillation frequency fv is varied in the sweep oscillation. Therefore, the operator can set the variation range vR as appropriate.

### OTHER EMBODIMENTS

The embodiment described above can be modified as follows, for example. The workpiece mass estimation device 100 may be installed for a machine other than the machine tool 200. Instead of inputting the torque command value for oscillation, the oscillation unit 10 may input a position command or a rotational speed command for oscillation.

According to the embodiments described above, the workpiece mass estimation devices of additional remarks 1 to 4 described below can be realized.

### Additional Remark 1

A workpiece mass estimation device (100) for estimating a mass of a workpiece (W), for a machine (200) including: a workpiece loading unit (90) on which the workpiece (W) is loaded; a motor (70) including a rotor (78) and a stator (76) for rotating the rotor (78); a transmission mechanism (80) for transmitting a motor output (Mo) as a force for rotating the rotor (78) to the workpiece loading unit (90); a sensor (60) for detecting motor information (Mi) indicating a state of the motor (70); and a motor control unit (50) for controlling the motor (70) based on the detected motor information (Mi), in which the machine (200) drives a driven object (Db) including the rotor (78), the transmission mechanism (80), the workpiece loading unit (90), and the workpiece (W) by the motor output (Mo),
the workpiece mass estimation device (100) including:
an oscillation unit (10) configured to command the motor control unit (50) to perform sweep oscillation that oscillates the motor output (Mo) and varies an oscillation frequency (fv);
a calculation unit (20) configured to, based on the motor information (Mi) detected at a plurality of detection time points (P) within an execution period of the sweep oscillation, calculate a total inertia (J) as an inertia of the driven object (Db) for each detection time point (P);
an identification unit (30) configured to identify a time point of an oscillation frequency (fv) at which it is determined that a change in the total inertia (J) accompanying a change to an adjacent oscillation frequency (fv) is minimized within the execution period; and
an estimation unit (40) configured to estimate the mass of the workpiece (W) by calculating an inertia of the workpiece (W) by subtracting an inertia of a general driven object (Db) including the rotor (78), the transmission mechanism (80), and the workpiece loading unit (90) from the total inertia (J) corresponding to the identified time point.

### Additional Remark 2

The workpiece mass estimation device (100) according to additional remark 1, in which the oscillation unit (10) commands the sweep oscillation by inputting a torque command value for oscillation to the motor control unit (50), and by varying an oscillation frequency (fv) of the torque command value.

### Additional Remark 3

The workpiece mass estimation device (100) according to additional remark 1 or 2, in which the oscillation unit (10) is capable of changing a variation range (vR) in which the oscillation frequency (fv) is varied in the sweep oscillation.

### Additional Remark 4

The workpiece mass estimation device (100) according to any one of additional remarks 1 to 3,
in which the identification unit (30), by identifying the time point of the oscillation frequency (fv) at which it is determined that the change in the total inertia is minimized,
identifies a time point of the oscillation frequency (fv) that does not overlap any of the following frequency bands:
a first frequency band (B1) in which a moving speed of the workpiece loading unit (90) becomes so slow that a Coulomb friction becomes dominant, and dead zones occur in a current value of the motor (70) and a rotational speed of the rotor (78);
a second frequency band (B2) in which resonance with the machine occurs, and
a third frequency band (B3) in which the moving speed of the workpiece loading unit (90) becomes so fast that the moving speed is out of a band of control response in control of the motor (70).

According to the workpiece mass estimation devices (100) of additional remarks 1 to 4 described above, the mass of the workpiece (W) can be estimated with high accuracy.

Although the present disclosure has been described in detail above, the present disclosure is not limited to the individual embodiments described above. Various additions, substitutions, modifications, partial deletions, and the like can be made to these embodiments without departing from the gist of the present disclosure or the spirit of the present disclosure derived from the contents recited in the claims and the equivalents thereof. These embodiments can also be implemented in combination. For example, in the above-described embodiments, the order of each operation and the order of each process are shown as examples, and the present disclosure is not limited thereto. The same applies to the case where numerical values or equations are used in the descriptions of the above-described embodiments.

### EXPLANATION OF REFERENCE NUMERALS

10 oscillation unit
20 calculation unit
30 identification unit
40 estimation unit
50 motor control unit
60 sensor
70 motor
76 stator
78 rotor
80 transmission mechanism
90 workpiece loading unit
100 workpiece mass estimation device
200 machine tool
B1 first frequency band
B2 second frequency band
B3 third frequency band
Db driven object
fv oscillation frequency
J total inertia
Mi motor information
Mo motor output
vR variation range
W workpiece

1. A workpiece mass estimation device for estimating a mass of a workpiece, for a machine comprising: a workpiece loading unit on which the workpiece is loaded; a motor comprising a rotor and a stator for rotating the rotor; a transmission mechanism for transmitting a motor output as a force for rotating the rotor to the workpiece loading unit; a sensor for detecting motor information indicating a state of the motor; and a motor control unit for controlling the motor based on the detected motor information, wherein the machine drives a driven object comprising the rotor, the transmission mechanism, the workpiece loading unit, and the workpiece by the motor output,
the workpiece mass estimation device comprising:
an oscillation unit configured to command the motor control unit to perform sweep oscillation that oscillates the motor output and varies an oscillation frequency;
a calculation unit configured to, based on the motor information detected at a plurality of detection time points within an execution period of the sweep oscillation, calculate a total inertia as an inertia of the driven object for each detection time point;
an identification unit configured to identify a time point of an oscillation frequency at which it is determined that a change in the total inertia accompanying a change to an adjacent oscillation frequency is minimized within the execution period; and
an estimation unit configured to estimate the mass of the workpiece by calculating an inertia of the workpiece by subtracting an inertia of a general driven object comprising the rotor, the transmission mechanism, and the workpiece loading unit from the total inertia corresponding to the identified time point.

2. The workpiece mass estimation device according to claim 1, wherein the oscillation unit commands the sweep oscillation by inputting a torque command value for oscillation to the motor control unit, and by varying an oscillation frequency of the torque command value.

3. The workpiece mass estimation device according to claim 1, wherein the oscillation unit is capable of changing a variation range in which the oscillation frequency is varied in the sweep oscillation.

4. The workpiece mass estimation device according to claim 1,
wherein the identification unit, by identifying the time point of the oscillation frequency at which it is determined that the change in the total inertia is minimized, identifies a time point of the oscillation frequency that does not overlap any of the following frequency bands:
a first frequency band in which a moving speed of the workpiece loading unit becomes so slow that a Coulomb friction becomes dominant, and dead zones occur in a current value of the motor and a rotational speed of the rotor,
a second frequency band in which resonance with the machine occurs, and
a third frequency band in which the moving speed of the workpiece loading unit becomes so fast that the moving speed is out of a band of control response in control of the motor
